(19) United States
(12) Patent Application Publication
(10) Pub. No.: US 2026/0255352 A1
(43) Pub. Date: Aug. 27, 2026

(54) COMMUNICATION METHOD, APPARATUS AND SYSTEM, AND STORAGE MEDIUM

(71) Applicant: BEIJING XIAOMI MOBILE SOFTWARE CO., LTD., Beijing (CN)

(72) Inventor: Xueyuan GAO, Beijing (CN)

(73) Assignee: BEIJING XIAOMI MOBILE SOFTWARE CO., LTD., Beijing (CN)

(21) Appl. No.: 19/162,082

(22) PCT Filed: Mar. 9, 2023
(86) PCT No.: PCT/CN2023/080628

§ 371 Date: Sep. 4, 2025

(51) Int. Cl. H04W 72/21; H04W 52/02

(52) U.S. Cl. CPC H04W 72/21; H04W 52/0235

(57) ABSTRACT

A communication method performed by a terminal includes transmitting event information, the terminal supports uplink simultaneous transmission via multi-panel (STxMP), the event information is used to schedule a transmission parameter for the terminal, and the transmission parameter includes at least one of a transmission scheme or precoding information.

### CROSS-REFERENCE TO RELATED APPLICATIONS

The present application is a U.S. National Stage of International Application No. PCT/CN2023/080628, filed on Mar. 9, 2023, the content of which is incorporated herein by reference in its entirety for all purposes.

### FIELD

The present disclosure relates to the field of communication technology, and in particular to a communication method, device and system, and a storage medium.

### BACKGROUND

When a terminal performs uplink simultaneous transmission via multi-panel (STxMP), the terminal may receive a plurality of precoding indications sent by a network device, and the plurality of precoding indications are used to respectively indicate different transmission schemes in different transmission modes, to meet the implementation and configuration needs of the terminal. How the network device knows the implementation and configuration needs of the terminal under STxMP is a technical problem that needs to be solved.

### SUMMARY

According to a first aspect of embodiments of the present disclosure, there is provided a communication method, which is performed by a terminal and includes: transmitting event information, in which the terminal supports uplink simultaneous transmission via multi-panel (STxMP), the event information is used to schedule a transmission parameter for the terminal, and the transmission parameter includes a transmission scheme and/or precoding information.

According to a second aspect of embodiments of the present disclosure, there is provided a communication method, which is performed by a network device and includes: receiving event information reported by a terminal, in which the terminal supports uplink simultaneous transmission via multi-panel (STxMP); and scheduling a transmission parameter based on the event information, in which the transmission parameter includes at least one of a transmission scheme or precoding information.

According to a third aspect of embodiments of the present disclosure, there is provided a communication system, which includes: a terminal configured to transmit event information; and a network device configured to receive the event information reported by the terminal, and schedule a transmission parameter based on the event information. The terminal supports uplink simultaneous transmission via multi-panel (STxMP), the event information is used to schedule the transmission parameter for the terminal, and the transmission parameter includes at least one of a transmission scheme or precoding information

According to a fourth aspect of embodiments of the present disclosure, there is provided a communication device, which includes: a processor; a memory configured to store instructions executable by the processor, and in which the processor is configured to perform the method according to the first aspect or any of the implementations of the first aspect.

According to a fifth aspect of embodiments of the present disclosure, there is provided a communication device, which includes: a processor; a memory configured to store instructions executable by the processor, and in which the processor is configured to perform the method according to the second aspect or any of the implementations of the second aspect.

### BRIEF DESCRIPTION OF THE DRAWINGS

The accompanying drawings herein are incorporated into the specification and constitute a part of the specification. Theses accompanying drawings illustrate embodiments conform to the present disclosure and are used to explain the principles of the present disclosure together with the specification.

FIG. 1 is a schematic diagram of a wireless communication system illustrated according to an illustrative embodiment.

FIG. 2 is a schematic diagram of a MTRP transmission mode under S-DCI scheduling illustrated according to an illustrative embodiment.

FIG. 3 is a schematic diagram of a MTRP transmission mode under M-DCI scheduling illustrated according to an illustrative embodiment.

FIG. 4 is a flow chart of a communication method illustrated according to an illustrative embodiment.

FIG. 5 is a flow chart of a communication method illustrated according to an illustrative embodiment.

FIG. 6 is a block diagram of a communication device illustrated according to an illustrative embodiment.

FIG. 7 is a block diagram of a communication device illustrated according to an illustrative embodiment.

FIG. 8 is a block diagram of a communication system illustrated according to an illustrative embodiment.

FIG. 9 is a block diagram of a communication device illustrated according to an illustrative embodiment.

FIG. 10 is a block diagram of a communication device illustrated according to an illustrative embodiment.

### DETAILED DESCRIPTION

Illustrative embodiments will be illustrated in detail herein, and the examples thereof are illustrated in the accompanying drawings. When the following description refers to the accompanying drawings, unless otherwise specified, the same or similar elements are denoted by the same numerals in the different accompanying drawings. Implementations described in the illustrative embodiments do not represent all implementations consistent with the present disclosure.

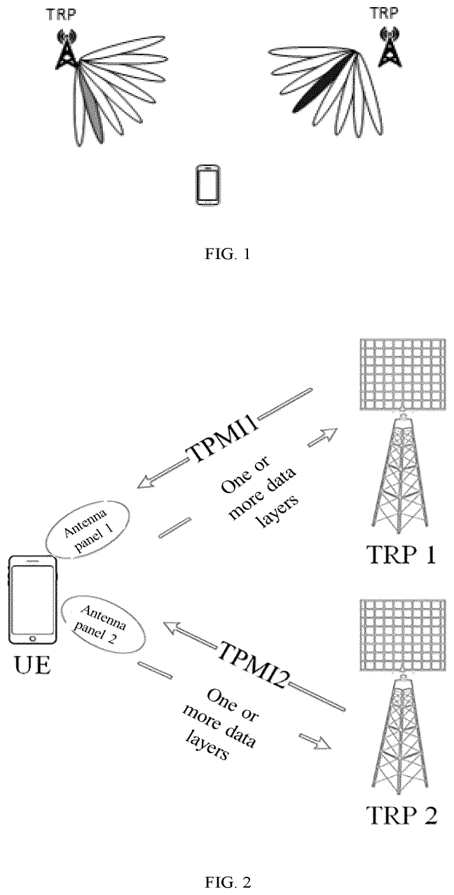

The communication method of embodiments of the present disclosure can be applied to a wireless communication system illustrated in FIG. 1. As illustrated in FIG. 1, the wireless communication system includes a network device and a terminal. The terminal is connected with the network device and carries out data transmission through a wireless resource.

It can be understood that the wireless communication system illustrated in FIG. 1 is only a schematic description, and the wireless communication system may also include other network devices, such as a core network device, a wireless relay device, a wireless backhaul device, and the like, which are not depicted in FIG. 1. Embodiments of the present disclosure do not limit the number of network devices and the number of terminals included in the wireless communication system.

It can be further understood that the wireless communication system of embodiments of the present disclosure is a network that provides wireless communication functions. The wireless communication system may employ different communication technologies such as code division multiple access (CDMA), wideband code division multiple access (WCDMA), time division multiple access (TDMA), frequency division multiple access (FDMA), orthogonal frequency-division multiple access (OFDMA), single carrier frequency division multiple access (SC-FDMA), carrier sense multiple access with collision avoidance. According to the capacity, speed, delay and other factors of different networks, networks can be divided into 2G (generation) networks, 3G networks, 4G networks or future evolution networks, such as 5G networks. 5G networks can also be called new radio (NR). For convenience of description, the present disclosure sometimes refers to a wireless communication network simply as a network.

Further, the network device involved in the present disclosure may also be referred to as a wireless access network device or a core network device. The wireless access network device may be a base station, an evolved node B (base station), a home base station, an access point (AP) in a wireless fidelity (WIFI) system, a radio relay node, a radio backhaul node, a transmission point (TP), a transmission and reception point (TRP), or the like, or may be a gNB in an NR system, or may be a component or a part of a device constituting a base station, or the like. It should be understood that embodiments of the present disclosure do not limit the specific technology and the specific device form used for the network device. In the present disclosure, the network device may provide communication coverage for a specific geographical area, and may communicate with a terminal located within the coverage area (cell). In addition, when it is a vehicle-to-everything (V2X) communication system, the network device may also be an in-vehicle device.

Further, the terminal involved in the present disclosure may be referred to as a terminal device, a user equipment (UE), a mobile station (MS), a mobile terminal (MT), or the like, and is a device that provides voice and/or data connectivity to a user, and may be, for example, a handheld device, an in-vehicle device, or the like having a wireless connection function. Currently, examples of some terminals include a mobile phone, a customer premise equipment (CPE), a pocket personal computer (PPC), a handheld computer, a personal digital assistant (PDA), a notebook computer, a tablet computer, a wearable device, or an in-vehicle device. In addition, when it is a vehicle-to-everything (V2X) communication system, the terminal device may also be an in-vehicle device. It should be understood that embodiments of the present disclosure do not limit the specific technology and the specific device form used for the terminal.

In NR system, multi-point cooperation technology is an important technical means to improve the coverage of cell edge and provide more balanced service quality in the service cell. From the perspective of network morphology, multi-point cooperation technology uses a large number of distributed access points combined with baseband centralized processing to deploy the network, which is more conducive to providing a balanced user experience rate and significantly reducing the delay and signaling overhead caused by handover. With the increase of frequency bands, from the perspective of ensuring network coverage, relatively dense deployment of access points is also needed. In the high frequency band, with the improvement of the integration of active antenna equipment, there will be a greater tendency to adopt a modular active antenna array. The antenna array of each TRP can be divided into several relatively independent panels, so the shape and number of ports of the entire array can be flexibly adjusted according to deployment scenarios and business requirements. Panels or TRPs can also be connected by optical fiber for more flexible distributed deployment. In millimeter wave band, as the wavelength decreases, the blocking effect caused by obstacles such as human bodies or vehicles will be more significant. In this case, from the viewpoint of ensuring the robustness of the link connection, it is also possible to use cooperation between a plurality of TRPs or panels to use a plurality of beams at a plurality of angles for transmission/reception, thereby reducing adverse effects caused by the blocking effect.

According to the mapping relationship of the transmitted signal stream to multiple TRPs/panels, multi-point cooperative transmission technology can be divided into coherent and non-coherent transmission. During coherent transmission, each data layer will be mapped onto multiple TRPs/panels through weighting vectors. During non-coherent transmission, each data stream is mapped to only a part of TRPs/panels. Coherent transmission has higher requirements for the synchronization between transmission points and the transmission capability of a backhaul link, so it is sensitive to many non-ideal factors in real deployment conditions. Relatively speaking, incoherent transmission is less affected by the above factors, so it is the key consideration scheme of multi-point transmission technology. The uplink physical uplink shared channel (PUSCH) transmission is transmitted in the direction of TRPs of multiple base stations. In some implementations of the present disclosure, multi-point cooperative transmission may be performed in a time division multiplexing (TDM) transmission mode, such as transmitting different repetitions of the same information on the PUSCH in a time-division manner to different TRPs of the base station through different transmission occasions (TO) in the time domain. This method requires relatively low terminal capabilities, does not require the ability to support simultaneous transmission beams, and has a large transmission delay.

For the uplink, the actual spatial characteristics of PUSCH channels facing different TRPs may be very different. Therefore, it is considered that quasi-co-location-D (QCL-D) of PUSCH channels having different transmission directions is different.

In some implementations of the present disclosure, only the uplink transmission enhancement for multiple transmission reception points (MTRP) under single downlink control information (S-DCI) is considered, and the uplink PUSCH transmission is transmitted towards the TRPs of multiple base stations. Further, it is desirable that simultaneous cooperative transmission by multiple terminal panels towards the TRPs of multiple base stations is realized to increase the reliability and throughput of transmission, and at the same time, the transmission delay under multiple TRPs can be effectively reduced, but the terminal is required to have the ability to simultaneously transmit multiple beams. The transmission of the PUSCH may be based on a single physical downlink control channel (PDCCH), that is, multi-panel/TRP transmission scheduled by S-DCI, as illustrated in FIG. 2. The UE communicates with the TPR1 of the base station through the panel 1, for example, receives first precoding indication information 1 (TPMI1) transmitted by the TPR1, and transmits one or more data layers to the TRP1, and communicates with the TPR2 of the base station through the panel 2, for example, receives second precoding indication information 2 (TPMI2) transmitted by the TPR2, and transmits one or more data layers to the TRP2.

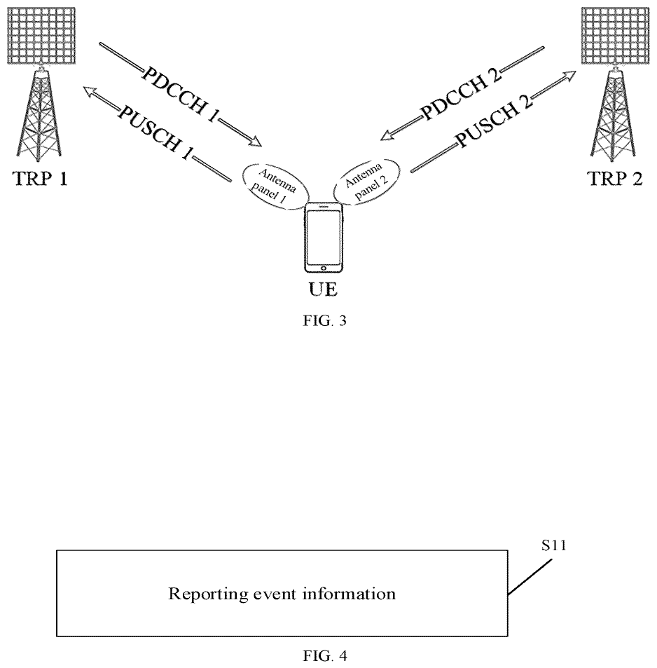

The transmission of the PUSCH may be based on multi-panel/TRP transmission scheduled by different PDCCHs, that is, multiple pieces of single-downlink control information (M-DCI), as illustrated in FIG. 3. The UE communicates with the TPR1 of the base station through the panel 1, for example, receives the PDCCHI transmitted by the TRP1, and transmits the PUSCHI to the TRP1, and communicates with the TPR2 of the base station through the panel 2, for example, receives the PDCCH2 transmitted by the TRP2, and transmits the PUSCH2 to the TRP2.

In actual deployment, the link between transmission points may be a relatively ideal backhaul link that supports high throughput and very low backhaul latency, or it may be a non-ideal backhaul link using x digital subscriber line (xDSL), microwave and relay. The non-coherent joint transmission (NC-JT) transmission scheme based on M-DCI is initially introduced mainly for non-ideal backhaul situations, but this scheme can also be used for ideal backhaul situations.

The terminal is generally configured with multiple physical panels, and different panels may have different capabilities. For example, they have different numbers of sounding reference signal (SRS) ports, and the maximum number of supported data transmission layers may not necessarily be the same. For example, one panel supports up to 2 layers of transmission, and the other panel supports up to 4 layers of transmission. The network scheduler will determine whether the terminal is currently suitable for uplink simultaneous transmission via multi-panel. If the terminal is currently suitable for uplink simultaneous transmission via multi-panel and is scheduled at the same time, the network will directly or indirectly indicate relevant transmission parameters, including the specific beam indication information of the terminal, the number of data layers used for transmission, the port allocation of the demodulation reference signal (DMRS) used, and the precoding indication information.

In some implementations of the present disclosure, transmission schemes supported by uplink simultaneous transmission via multi-panel (STxMP) for S-DCI-based PUSCH include a space division multiplexing (SDM) scheme and a single frequency network (SFN) scheme. The SDM scheme means that different parts of a transport block (TB) of the PUSCH are respectively transmitted to two different TRPs on the same time-frequency resource through corresponding DMRS ports or port combinations allocated on different panels, and different panels/TRP/TO are respectively associated with different TCI states, that is, beams. The SFN scheme means that one TB of the PUSCH is transmitted to two different TRPs on the same time-frequency resource through the same DMRS port or port combination allocated on different panels, and different panels/TRP/TO are respectively associated with different TCI states, that is, beams.

That is, in the study of STxMP enhancement, S-DCI based scheduling currently supports an SFN transmission scheme in addition to an SDM transmission scheme supporting an uplink MTRP. The network device instructs the terminal to dynamically switch between the MTRP and the STRP through an SRS resource set indicator. How to implement the indication scheme of different precoding indications in different transmission modes to adapt to the implementation and configuration of different terminals is a problem to be solved.

In view of this, embodiments of the present disclosure provide an event reporting method of a terminal. The terminal supporting STxMP actively reports event information, such that the network device can schedule a transmission parameter and perform precoding indication for the terminal according to the event information reported by the terminal, enabling uplink PUSCH transmission to support a higher transmission rate and a higher throughput rate, thus realizing optimization of an indication scheme for the terminal.

FIG. 4 is a flow chart of a communication method according to an illustrative embodiment, as illustrated in FIG. 4, the method is performed by a terminal and includes the following steps.

In step S11, event information is reported.

The terminal supports uplink STxMP, the event information is used to schedule a transmission parameter for the terminal, and the transmission parameter includes a transmission scheme and/or precoding information.

In an example, the event information of the terminal can be used for the network device to schedule the transmission parameter for the terminal, and the network device scheduling the transmission parameter for the terminal may include configuring and/or indicating the transmission parameter for the terminal by the network device. For example, the event information of the terminal is used for the network device to configure a transmission scheme for the terminal, or configure precoding information for the terminal, or configure a transmission scheme and precoding information for the terminal. Alternatively, the event information of the terminal is used for the network device to indicate a transmission scheme for the terminal, or indicate precoding information for the terminal, or indicate a transmission scheme and precoding information for the terminal. Alternatively, the event information of the terminal is used for the network device to configure the transmission scheme and indicate a transmission scheme for the terminal, or configure the precoding information and indicate the precoding information for the terminal. The network device may configure a transmission scheme for the terminal, or configure precoding information for the terminal through RRC signaling with reference to the received the event information of the terminal. The network device may also indicate the transmission scheme of the terminal or indicate precoding information of the terminal through MAC CE or downlink control information (DCI) with reference to the received event information of the terminal.

In an example, if the terminal supports uplink STxMP and multiple panels of the terminal are scheduled at the same time, the terminal may report the event information of the terminal to the network device. After receiving the event information of the terminal, the network device may configure and/or indicate the transmission parameter for the terminal with reference to the event information. That is, when the network device configures that the current transmission scenario is STxMP, and the terminal has a service reduction, needs to save power itself, or the terminal is overheated, the terminal can actively report event information, prompting the network device that the terminal can switch to a transmission mode with lower power consumption. After receiving the event information of the terminal, the network device may re-configure and/or indicate the transmission parameter for the terminal, and perform a fallback from the STxMP transmission to reduce the power consumption of the terminal.

According to the technical solutions of embodiments of the present disclosure, the terminal supporting STxMP actively reports the event information, such that the network device can configure and/or indicate the transmission parameter and perform the precoding indication for the terminal according to the event information reported by the terminal, enabling the uplink PUSCH transmission to support a higher transmission rate and a higher throughput rate, thus realizing optimization of the indication scheme for the terminal.

In a communication method according to embodiments of the present disclosure, the event information reported by the terminal may include at least one of:
suggesting to switch a currently scheduled transmission from simultaneous transmission via multi-panel and/or MTRP to single-panel and/or STRP transmission; suggesting to switch a currently scheduled transmission from simultaneous transmission via multi-panel and/or MTRP to MTRP TDM transmission; suggesting to switch a currently scheduled transmission from simultaneous transmission via multi-panel and/or MTRP to STRP transmission; suggesting to switch to single-panel and/or STRP transmission; suggesting to switch to MTRP TDM transmission; or suggesting to switch to STRP transmission. In embodiments of the present disclosure, the terminal may directly report the transmission scheme fallback proposal. The fallback of the transmission scheme may be switching from simultaneous transmission via multi-panel and/or MTRP to single-panel and/or STRP transmission, switching from simultaneous transmission via multi-panel and/or MTRP to MTRP TDM transmission, or switching from simultaneous transmission via multi-panel and/or MTRP to STRP transmission.

In an example, when the event information reported by the terminal includes a suggestion to switch the currently scheduled transmission from simultaneous transmission via multi-panel and/or MTRP to single-panel and/or STRP transmission, the network device may reconfigure and/or indicate the transmission parameter of the terminal with reference to the received event information, such that the terminal is fallback from STxMP transmission to single-panel and/or STRP transmission. That is, the currently scheduled transmission of the terminal is fallback from the simultaneous transmission via multi-panel and/or MTRP to the single-panel and/or STRP transmission.

For example, when the event information reported by the terminal includes a suggestion to switch the currently scheduled transmission from the simultaneous transmission via multi-panel to the single-panel transmission, the network device may reconfigure and/or indicate the transmission parameter of the terminal with reference to the received event information, such that the currently scheduled transmission of the terminal is fallback from the simultaneous transmission via multi-panel to the single-panel transmission. When the event information reported by the terminal includes a suggestion to switch the currently scheduled transmission from the simultaneous transmission via multi-panel to the STRP transmission, the network device may reconfigure and/or indicate the transmission parameter of the terminal with reference to the received event information, such that the currently scheduled transmission of the terminal is fallback from the simultaneous transmission via multi-panel to the STRP transmission. When the event information reported by the terminal includes a suggestion to switch the currently scheduled transmission from the simultaneous transmission via MTRP to the single-panel transmission, the network device may reconfigure and/or indicate the transmission parameter of the terminal with reference to the received event information, such that the currently scheduled transmission of the terminal is fallback from the simultaneous transmission via MTRP to the single-panel transmission. When the event information reported by the terminal includes a suggestion to switch the currently scheduled transmission from the simultaneous transmission via MTRP to the STRP transmission, the network device may reconfigure and/or indicate the transmission parameter of the terminal with reference to the received event information, such that the currently scheduled transmission of the terminal is fallback from the simultaneous transmission via MTRP to the STRP transmission. When the event information reported by the terminal includes a suggestion to switch the currently scheduled transmission from the simultaneous transmission via multi-panel and MTRP to the single-panel transmission, the network device may reconfigure and/or indicate the transmission parameter of the terminal with reference to the received event information, such that the currently scheduled transmission of the terminal is fallback from the simultaneous transmission via multi-panel and MTRP to the single-panel transmission. When the event information reported by the terminal includes a suggestion to switch the currently scheduled transmission from the simultaneous transmission via multi-panel and MTRP to the STRP transmission, the network device may reconfigure and/or indicate the transmission parameter of the terminal with reference to the received event information, such that the currently scheduled transmission of the terminal is fallback from the simultaneous transmission via multi-panel and MTRP to the STRP transmission. It should be noted that when the terminal is fallback to the single-panel transmission, the TRP may be an MTRP or a STRP.

When the event information reported by the terminal includes a suggestion to switch the currently scheduled transmission from simultaneous transmission via multi-panel and/or MTRP to MTRP TDM transmission, the network device may reconfigure and/or indicate the transmission parameter of the terminal with reference to the received event information, such that the terminal is fallback from STxMP transmission to transmission of a plurality of TRPs through TDM. That is, when the currently scheduled transmission of the terminal is fallback from simultaneous transmission via multi-panel and/or MTRP to the transmission of the plurality of TRPs through TDM, the terminal may use one panel to perform TMD transmission to a plurality of different TRPs, or may use a plurality of panels to perform TDM transmission to different TRPs.

For example, when the event information reported by the terminal includes a suggestion to switch the currently scheduled transmission from the simultaneous transmission via multi-panel to the MTRP TDM transmission, the network device may reconfigure and/or indicate the transmission parameter of the terminal with reference to the received event information, such that the currently scheduled transmission of the terminal is fallback from the simultaneous transmission via multi-panel to the MTRP TDM transmission. When the event information reported by the terminal includes a suggestion to switch the currently scheduled transmission from the simultaneous transmission via MTRP to the MTRP TDM transmission, the network device may reconfigure and/or indicate the transmission parameter of the terminal with reference to the received event information, such that the currently scheduled transmission of the terminal is fallback from the simultaneous transmission via MTRP to the MTRP TDM transmission. When the event information reported by the terminal includes a suggestion to switch the currently scheduled transmission from the simultaneous transmission via multi-panel and MTRP to the MTRP TDM transmission, the network device may reconfigure and/or indicate the transmission parameter of the terminal with reference to the received event information, such that the currently scheduled transmission of the terminal is fallback from the simultaneous transmission via multi-panel and MTRP to the MTRP TDM transmission.

When the event information reported by the terminal includes a suggestion to switch the currently scheduled transmission from simultaneous transmission via multi-panel and/or MTRP to the STRP transmission, the network device may reconfigure and/or indicate the transmission parameter of the terminal with reference to the received event information, such that the terminal is fallback from the STxMP to the STRP-based transmission. That is, the currently scheduled transmission of the terminal is fallback from the simultaneous transmission via multi-panel and/or MTRP to the STRP-based transmission.

For example, when the event information reported by the terminal includes a suggestion to switch the currently scheduled transmission from the simultaneous transmission via multi-panel to the STRP transmission, the network device may reconfigure and/or indicate the transmission parameter of the terminal with reference to the received event information, such that the currently scheduled transmission of the terminal is fallback from the simultaneous transmission via multi-panel to the STRP transmission. When the event information reported by the terminal includes a suggestion to switch the currently scheduled transmission from the simultaneous transmission via MTRP to the STRP transmission, the network device may reconfigure and/or indicate the transmission parameter of the terminal with reference to the received event information, such that the currently scheduled transmission of the terminal is fallback from the simultaneous transmission via MTRP to the STRP transmission. When the event information reported by the terminal includes a suggestion to switch the currently scheduled transmission from the simultaneous transmission via multi-panel and MTRP to the STRP transmission, the network device may reconfigure and/or indicate the transmission parameter of the terminal with reference to the received event information, such that the currently scheduled transmission of the terminal is fallback from the simultaneous transmission via multi-panel and MTRP to the STRP transmission.

In a communication method provided by an embodiment of the present disclosure, the event information reported by the terminal may include change information of a number of activated panels and/or panels available for MTRP and/or STRP transmission.

In embodiments of the present disclosure, the change information of the number of the activated panels and/or the panels available for MTRP and/or STRP transmission may include at least one of: a suggested reduction in the number of the activated panels and/or panels available for MTRP and/or STRP transmission; or a desired number of the activated panels and/or panels available for MTRP and/or STRP transmission.

In embodiments of the present disclosure, the terminal may report the change information of the number of the activated panels and/or the panels available for MTRP and/or STRP transmission. Here, the number information may be a suggested reduction in the number of activated panels and/or panels available for MTRP and/or STRP transmission, or may be directly reporting the desired number of activated panels and/or panels available for MTRP and/or STRP transmission.

The network device may reconfigure and/or indicate the transmission parameter for the terminal after receiving the change information of the number of activated panels and/or panels available for MTRP and/or STRP transmission reported by the terminal. The terminal after reconfiguration and/or indication may transmit based on MTRP or STRP. The MTRP transmission includes STxMP transmission and TDM transmission of MTRP. When the terminal after reconfiguration and/or indication is based on multi-panel transmission, STxMP transmission and TDM transmission of MTRP may be supported. When the terminal after reconfiguration and/or indication is based on single-panel transmission, STRP transmission and TDM transmission of MTRP may be supported.

In an example, if the number of currently activated panels of the terminal is N, the terminal may report the event information suggesting a reduction in the number of activated panels. After receiving the event information suggesting the reduction in the number of activated panels, the network device may reconfigure and/or indicate the transmission parameter for the terminal with reference to the event information, such that the number of activated panels of the terminal after the reconfiguration and/or indication is N-P. On the other hand, the terminal may also report that the desired number of activated panels is Q. After receiving the desired number of activated panels of the terminal, the network device may reconfigure and/or indicate the transmission parameter for the terminal with reference to the event information, such that the number of activated panels of the terminal after the reconfiguration and/or indication is Q. Where N is a positive integer greater than 1, and P and Q are positive integers less than N.

In another example, if the number of panels currently available for MTRP and/or STRP transmission of the terminal is M, the terminal may report event information suggesting a reduction in the number of panels available for MTRP and/or STRP transmission. After receiving the event information suggesting the reduction in the number of panels available for MTRP and/or STRP transmission, the network device may reconfigure and/or indicate the transmission parameter for the terminal with reference to the event information, such that the number of panels available for MTRP and/or STRP transmission of the terminal after the reconfiguration and/or indication is M-K. On the other hand, the terminal may also report that the desired number of panels available for MTRP and/or STRP transmission is L. After receiving the desired number of panels available for MTRP and/or STRP transmission of the terminal, the network device may reconfigure and/or indicate the transmission parameter for the terminal with reference to the event information, such that the number of panels available for MTRP and/or STRP transmission of the terminal after the reconfiguration and/or indication is L. Where M is a positive integer greater than 1, and K and L are positive integers less than N.

In a communication method provided by embodiments of the present disclosure, the event information reported by the terminal may include terminal status information. The terminal status information may be used to indicate that the terminal cannot currently support STxMP.

In embodiments of the present disclosure, the terminal status information may be reported in response to the terminal satisfying at least one of:
a remaining power of the terminal is less than a first power threshold;
the terminal is configured in a power saving mode; or
the terminal detects that a device area temperature is greater than a first temperature threshold.

In embodiments of the present disclosure, the terminal status information may include at least one of: terminal power saving reminder information for reminding the network device that the terminal needs or has entered a power saving mode and cannot support STxMP; or terminal overheating reminder information for reminding the network device that the terminal is in an overheated state and cannot support STxMP.

In embodiments of the present disclosure, the terminal may report the terminal status information. The terminal status information may be the terminal power saving reminder information or the terminal overheating reminder information.

In an example, when the terminal based on STxMP transmission is in need of reducing its own service, or the remaining power is less than the first power threshold, and the terminal is configured by the user to enter a power saving mode, the terminal may report the terminal power saving reminder information such that the network device can perform a fallback from the STxMP transmission after receiving the terminal power saving reminder information, reducing the power consumption of the terminal. A value of the first power threshold may be set according to actual needs, which is not limited here. In an example, the first power threshold may be, for example, 20% of a total battery capacity of the terminal.

On the other hand, when the terminal based on the STxMP transmission detects that the device area temperature is greater than the first temperature threshold, the terminal overheating reminder information may be reported such that the network device can perform a fallback from the STxMP transmission after receiving the terminal overheating reminder information, reducing the power consumption of the terminal and lowering the temperature of the terminal. Similarly, the value of the first temperature threshold may be set according to actual needs, which is not limited here.

In embodiments of the present disclosure, the event information further includes recovery reminder information, and the recovery reminder information reminds the network device that the terminal supports STxMP.

In an example, the recovery reminder information may include at least one of:
suggesting to switch the currently scheduled transmission from single-panel and/or STRP transmission to simultaneous transmission via multi-panel and/or MTRP;
suggesting to switch the currently scheduled transmission from MTRP TDM transmission to simultaneous transmission via multi-panel and/or MTRP;
suggesting to switch the currently scheduled transmission from STRP transmission to simultaneous transmission via multi-panel and/or MTRP; or
suggesting to switch to simultaneous transmission via multi-panel and/or MTRP.

In another example, the recovery reminder information may further include at least one of:
a suggested increase in a number of activated panels and/or panels available for MTRP and/or STRP transmission; or
a desired number of activated panels and/or a desired number of panels available for MTRP and/or STRP transmission.

In yet another example, the recovery reminder information may further include terminal status recovery reminder information for indicating that the terminal can currently support STxMP. In an implementation, the terminal may report the terminal status recovery reminder information in response to satisfying at least one of the following conditions:
the remaining power of the terminal is greater than a second power threshold;
the terminal is configured to release the power saving mode; or
the terminal detects that the device area temperature is less than the second temperature threshold.

In embodiments of the present disclosure, when the power of the terminal in the power saving mode is restored to greater than the second power threshold, and/or when the terminal detects that the device area temperature is less than the second temperature threshold, the terminal may report the terminal status recovery reminder information, such that the network device configures the terminal to resume STxMP transmission with reference to the terminal status recovery reminder information reported by the terminal. Where the second power threshold is greater than the first power threshold, and the second temperature threshold is less than the first temperature threshold. Under the premise that the above conditions are satisfied, the value of the second power threshold and the second temperature threshold may be set according to actual needs, which is not limited here.

In embodiments of the present disclosure, the event information may be carried in the radio resource control (RRC) signaling, in the medium access control control element (MAC CE), or in the uplink control information (UCI).

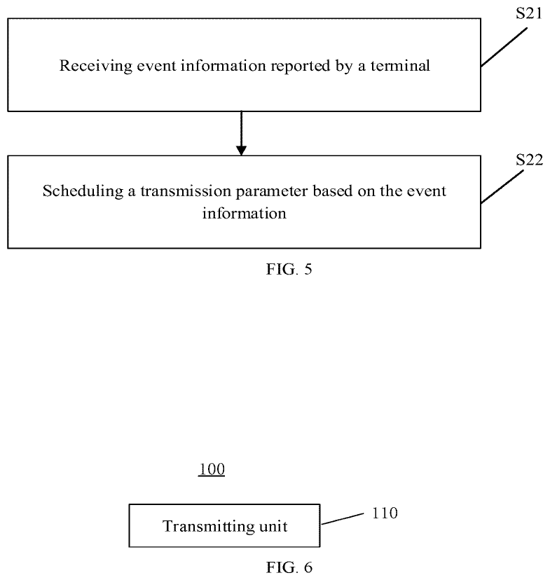

FIG. 5 is a flow chart of a communication method illustrated according to an illustrative embodiment, and as illustrated in FIG. 5, the communication method is performed by a network device and includes the following steps.

In step S21, event information reported by a terminal is received.

The terminal supports uplink simultaneous transmission via multi-panel (STxMP).

In step S22, the transmission parameter is scheduled based on the event information.

The transmission parameter includes a transmission scheme and/or precoding information.

The network device may configure the terminal to operate in an uplink STxMP scenario, and the network device may further schedule the transmission parameter for the terminal with reference to the received event information, and the transmission parameter includes the transmission scheme and/or the precoding information.

In an example, the network device may schedule the transmission parameter for the terminal with reference to the received event information of the terminal, and the network device scheduling the transmission parameter for the terminal may include configuring and/or indicating the transmission parameter for the terminal by the network device. For example, the network device may configure the transmission scheme for the terminal, configure the precoding information for the terminal, or configure the transmission scheme and the precoding information for the terminal with reference to the received event information of the terminal. Alternatively, the network device indicates the transmission scheme for the terminal, indicates the precoding information for the terminal, or indicates the transmission scheme and the precoding information for the terminal with reference to the received event information of the terminal. Alternatively, the network device configures a transmission scheme and indicates a transmission scheme for the terminal, or configures precoding information and indicates precoding information for the terminal with reference to the received event information of the terminal. The network device may configure a transmission scheme for the terminal, or configure precoding information for the terminal through RRC signaling with reference to the received the event information of the terminal. The network device may also indicate the transmission scheme of the terminal or indicate precoding information of the terminal through MAC CE or downlink control information (DCI) with reference to the received event information of the terminal.

In an example, if the network device configures the terminal to operate in an uplink STxMP scenario, and multiple panels of the terminal are scheduled at the same time, the network device may receive the event information reported by the terminal. After receiving the event information of the terminal, the network device may configure and/or indicate the transmission parameter for the terminal with reference to the event information. That is, when the network device configures that the current transmission scenario is STxMP, and the terminal has a service reduction, needs to save power itself, or the terminal is overheated, the terminal can actively report event information, prompting the network device that the terminal can switch to a transmission mode with lower power consumption. After receiving the event information of the terminal, the network device may re-configure and/or indicate the transmission parameter for the terminal, and perform a fallback from the STxMP transmission to reduce the power consumption of the terminal.

According to the technical solution of embodiments of the present disclosure, by receiving the event information reported by the terminal supporting STxMP, the network device can configure and/or indicate the transmission parameter and perform the precoding indication for the terminal according to the event information reported by the terminal, enabling the uplink PUSCH transmission to support a higher transmission rate and a higher throughput rate, and thus realizing optimization of the indication scheme for the terminal.

In a communication method according to embodiments of the present disclosure, the event information reported by the terminal may include at least one of:
suggesting to switch a currently scheduled transmission from simultaneous transmission via multi-panel and/or MTRP to single-panel and/or STRP transmission;
suggesting to switch a currently scheduled transmission from simultaneous transmission via multi-panel and/or MTRP to MTRP TDM transmission;
suggesting to switch a currently scheduled transmission from simultaneous transmission via multi-panel and/or MTRP to STRP transmission;
suggesting to switch to single-panel and/or STRP transmission;
suggesting to switch to MTRP TDM transmission; or
suggesting to switch to STRP transmission.

In embodiments of the present disclosure, the event information received by the network device may directly indicate a transmission scheme fallback proposal. The fallback of the transmission scheme is the same as the fallback of the transmission scheme in the embodiments described above, and for details, reference may be made to the related description of the embodiments described above.

In an example, when the event information reported by the terminal includes a suggestion to switch the currently scheduled transmission from simultaneous transmission via multi-panel and/or MTRP to single-panel and/or STRP transmission, the network device may reconfigure and/or indicate the transmission parameter of the terminal with reference to the received event information, such that the terminal is fallback from STxMP transmission to single-panel and/or STRP transmission. That is, the currently scheduled transmission of the terminal is fallback from the simultaneous transmission via multi-panel and/or MTRP to the single-panel and/or STRP transmission.

When the event information reported by the terminal includes a suggestion to switch the currently scheduled transmission from simultaneous transmission via multi-panel and/or MTRP to MTRP TDM transmission, the network device may reconfigure and/or indicate the transmission parameter of the terminal with reference to the received event information, such that the terminal is fallback from STxMP transmission to transmission of a plurality of TRPs through TDM. That is, when the currently scheduled transmission of the terminal is fallback from simultaneous transmission via multi-panel and/or MTRP to the transmission of the plurality of TRPs through TDM, the terminal may use one panel to perform TMD transmission to a plurality of different TRPs, or may use a plurality of panels to perform TDM transmission to different TRPs.

When the event information reported by the terminal includes a suggestion to switch the currently scheduled transmission from simultaneous transmission via multi-panel and/or MTRP to the STRP transmission, the network device may reconfigure and/or indicate the transmission parameter of the terminal with reference to the received event information, such that the terminal is fallback from the STxMP to the STRP-based transmission. That is, the currently scheduled transmission of the terminal is fallback from the simultaneous transmission via multi-panel and/or MTRP to the STRP-based transmission.

In a communication method provided by an embodiment of the present disclosure, the event information reported by the terminal may include change information of a number of activated panels and/or panels available for MTRP and/or STRP transmission.

In embodiments of the present disclosure, the change information of the number of the activated panels and/or the panels available for MTRP and/or STRP transmission may include at least one of:
a suggested reduction in the number of activated panels and/or the number of panels available for MTRP and/or STRP transmission; or
a desired number of activated panels and/or a desired number of panels available for MTRP and/or STRP transmission.

In embodiments of the present disclosure, the event information received by the network device may indicate the change information of the number of activated panel and/or panels available for MTRP and/or STRP transmission. Here, the number information may be a suggested reduction in the number of activated panels and/or panels available for MTRP and/or STRP transmission, or may be directly reporting the desired number of activated panels and/or panels available for MTRP and/or STRP transmission.

In an example, if the number of currently activated panels of the terminal is N, the terminal may report the event information suggesting a reduction in the number of activated panels. After receiving the event information suggesting the reduction in the number of activated panels, the network device may reconfigure and/or indicate the transmission parameter for the terminal with reference to the event information, such that the number of activated panels of the terminal after the reconfiguration and/or indication is N-P. On the other hand, the terminal may also report that the desired number of activated panels is Q. After receiving the desired number of activated panels of the terminal, the network device may reconfigure and/or indicate the transmission parameter for the terminal with reference to the event information, such that the number of activated panels of the terminal after the reconfiguration and/or indication is Q. Where N is a positive integer greater than 1, and P and Q are positive integers less than N.

In another example, if the number of panels currently available for MTRP and/or STRP transmission of the terminal is M, the terminal may report event information suggesting a reduction in the number of panels available for MTRP and/or STRP transmission. After receiving the event information suggesting the reduction in the number of panels available for MTRP and/or STRP transmission, the network device may reconfigure and/or indicate the transmission parameter for the terminal with reference to the event information, such that the number of panels available for MTRP and/or STRP transmission of the terminal after the reconfiguration and/or indication is M-K. On the other hand, the terminal may also report that the desired number of panels available for MTRP and/or STRP transmission is L. After receiving the desired number of panels available for MTRP and/or STRP transmission of the terminal, the network device may reconfigure and/or indicate the transmission parameter for the terminal with reference to the event information, such that the number of panels available for MTRP and/or STRP transmission of the terminal after the reconfiguration and/or indication is L. Where M is a positive integer greater than 1, and K and L are positive integers less than N.

In a communication method provided by embodiments of the present disclosure, the event information reported by the terminal may include terminal status information. The terminal status information may be used to indicate that the terminal cannot currently support STxMP.

In embodiments of the present disclosure, the terminal status information may include at least one of:
terminal power saving reminder information for reminding a network device that the terminal needs or has entered a power saving mode and cannot support STxMP; or
terminal overheating reminder information for reminding a network device that the terminal is in an overheated state and cannot support STxMP.

In embodiments of the present disclosure, the event information received by the network device may indicate terminal status information. The terminal status information may be the terminal power saving reminder information or the terminal overheating reminder information.

In an example, when the terminal based on STxMP transmission is in need of reducing its own service, or the remaining power is less than the first power threshold, and the terminal is configured by the user to enter a power saving mode, the terminal may report the terminal power saving reminder information such that the network device can perform a fallback from the STxMP transmission after receiving the terminal power saving reminder information, reducing the power consumption of the terminal. A value of the first power threshold may be set according to actual needs, which is not limited here. In an example, the first power threshold may be, for example, 20% of the total battery capacity of the terminal.

On the other hand, when the terminal based on the STxMP transmission detects that the device area temperature is greater than the first temperature threshold, the terminal overheating reminder information may be reported such that the network device can perform a fallback from the STxMP transmission after receiving the terminal overheating reminder information, reducing the power consumption of the terminal and lowering the temperature of the terminal. Similarly, the value of the first temperature threshold may be set according to actual needs, which is not limited here.

In embodiments of the present disclosure, the event information further includes recovery reminder information, and the recovery reminder information reminds the network device that the terminal supports STxMP.

In an example, the recovery reminder information may include at least one of:
suggesting to switch the currently scheduled transmission from single-panel and/or STRP transmission to simultaneous transmission via multi-panel and/or MTRP;
suggesting to switch the currently scheduled transmission from MTRP TDM transmission to simultaneous transmission via multi-panel and/or MTRP;
suggesting to switch the currently scheduled transmission from STRP transmission to simultaneous transmission via multi-panel and/or MTRP; or
suggesting to switch to simultaneous transmission via multi-panel and/or MTRP.

In another example, the recovery reminder information may further include at least one of:
a suggested increase in a number of activated panels and/or panels available for MTRP and/or STRP transmission; or
a desired number of activated panels and/or a desired number of panels available for MTRP and/or STRP transmission.

In yet another example, the recovery reminder information may further include terminal status recovery reminder information for indicating that the terminal currently supports STxMP. In an implementation, the network device may receive terminal status recovery reminder information reported by the terminal, and the terminal status recovery reminder information is used to indicate that the power of the terminal in the power saving mode is restored to greater than the second power threshold, and/or the terminal detects that the device area temperature is less than the second temperature threshold. The network device may configure the terminal to resume STxMP transmission with reference to the terminal status recovery reminder information reported by the terminal. Where the second power threshold is greater than the first power threshold, and the second temperature threshold is less than the first temperature threshold. Under the premise that the above conditions are satisfied, the value of the second power threshold and the second temperature threshold may be set according to actual needs, which is not limited here.

In embodiments of the present disclosure, the event information may be carried in the radio resource control (RRC) signaling, in the medium access control control element (MAC CE), or in the uplink control information (UCI).

It can be understood that the technical implementation involved in the process in which the network device performs communication in embodiments of the present disclosure can be applied to the process in which the terminal performs communication in embodiments of the present disclosure, and therefore, where some technical implementation descriptions of the process in which the network device performs communication are not sufficiently detailed, reference may be made to the relevant description in the process in which the terminal performs communication, which will not be repeated here.

It can be understood that the communication method provided by embodiments of the present disclosure is applicable to a process in which the terminal and the network device interact with each other to realize communication. Embodiments of the present disclosure will not describe in detail the process of interacting and realizing communication between the terminal and the network device.

It should be noted that those skilled in the art can understand that the various implementations/embodiments described above in the embodiments of the present disclosure may be used in conjunction with the embodiments described above or may be used independently. Whether used alone or in conjunction with the embodiments described above, the principles of implementation are similar. In embodiments of the present disclosure, some embodiments are described with reference to implementations used together. Of course, those skilled in the art will understand that such illustrations are not limiting to embodiments of the present disclosure.

Based on the same concept, embodiments of the present disclosure further provide a communication device.

It can be understood that in order to realize the functions described above, the communication device provided by embodiments of the present disclosure includes a corresponding hardware structure and/or software module for executing each function. The embodiments of the present disclosure can be implemented in the form of hardware or a combination of hardware and computer software in combination with the units and algorithm steps of the examples disclosed in the embodiments of the present disclosure. Whether a function is performed in hardware or computer software driven hardware depends on the specific application and design constraints of the technical solution. Those skilled in the art may use different methods to implement the described functions for each specific application, but such implementation should not be considered to be beyond the scope of the technical solutions of the embodiments of the present disclosure.

FIG. 6 is a block diagram of a communication device illustrated according to an illustrative embodiment. As illustrated in FIG. 6, the device 100 includes a transmitting unit 110.

The transmission unit 110 is configured to report event information of the terminal.

The terminal supports uplink simultaneous transmission via multi-panel (STxMP), the event information is used to schedule a transmission parameter for the terminal, and the transmission parameter includes a transmission scheme and/or precoding information.

In embodiments of the present disclosure, the event information includes at least one of:
suggesting to switch a currently scheduled transmission from simultaneous transmission via multi-panel and/or MTRP to single-panel and/or STRP transmission;
suggesting to switch a currently scheduled transmission from simultaneous transmission via multi-panel and/or MTRP to MTRP TDM transmission;
suggesting to switch a currently scheduled transmission from simultaneous transmission via multi-panel and/or MTRP to STRP transmission;
suggesting to switch to single-panel and/or STRP transmission;
suggesting to switch to MTRP TDM transmission; or
suggesting to switch to STRP transmission.

In embodiments of the present disclosure, the event information includes change information of a number of activated panels and/or panels available for MTRP and/or STRP transmission.

In embodiments of the present disclosure, the change information of the number of activated panels and/or the panels available for STxMP transmission includes at least one of:
a suggested reduction in the number of activated panels and/or the number of panels available for MTRP and/or STRP transmission; or
a desired number of activated panels and/or a desired number of panels available for MTRP and/or STRP transmission.

In embodiments of the present disclosure, the event information includes terminal status information, in which the terminal status information indicates that the terminal currently cannot support STxMP.

In embodiments of the present disclosure, the terminal status information is reported in response to the terminal satisfying at least one of the following conditions:
a remaining power of the terminal is less than a first power threshold;
the terminal is configured in a power saving mode; or
the terminal detects that a device area temperature is greater than a first temperature threshold.

In embodiments of the present disclosure, the terminal status information includes at least one of:
terminal power saving reminder information for reminding a network device that the terminal needs or has entered a power saving mode and cannot support STxMP; or
terminal overheating reminder information for reminding a network device that the terminal is in an overheated state and cannot support STxMP.

In embodiments of the present disclosure, the event information includes recovery reminder information, and the recovery reminder information reminds the network device that the terminal supports STxMP.

In embodiments of the present disclosure, the event information is carried in the radio resource control (RRC) signaling, or in the medium access control control element (MAC CE), or in the uplink control information (UCI).

According to the technical solutions of embodiments of the present disclosure, the terminal supporting STxMP actively reports the event information, such that the network device can schedule the transmission parameter and perform the precoding indication for the terminal according to the event information reported by the terminal, enabling the uplink PUSCH transmission to support a higher transmission rate and a higher throughput rate, thus realizing optimization of the indication scheme for the terminal.

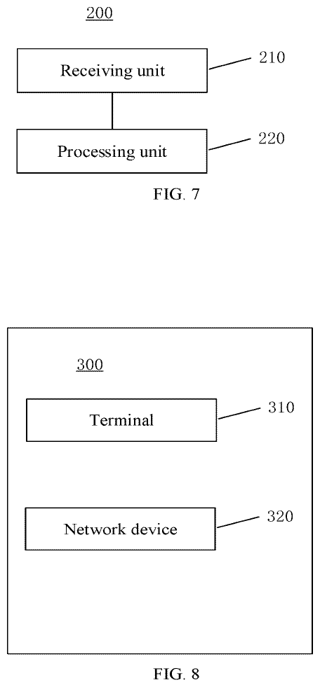

FIG. 7 is a block diagram of a communication device illustrated according to an illustrative embodiment. As illustrated in FIG. 7, the device 200 includes a receiving unit 210 and a processing unit 220.

The receiving unit 210 is configured to receive event information reported by the terminal.

The terminal supports uplink simultaneous transmission via multi-panel (STxMP).

The processing unit 220 is configured to schedule the transmission parameter based on the event information.

The transmission parameter includes a transmission scheme and/or precoding information.

In embodiments of the present disclosure, the event information includes at least one of:
suggesting to switch a currently scheduled transmission from simultaneous transmission via multi-panel and/or MTRP to single-panel and/or STRP transmission;
suggesting to switch a currently scheduled transmission from simultaneous transmission via multi-panel and/or MTRP to MTRP TDM transmission;
suggesting to switch a currently scheduled transmission from simultaneous transmission via multi-panel and/or MTRP to STRP transmission;
suggesting to switch to single-panel and/or STRP transmission;
suggesting to switch to MTRP TDM transmission; or suggesting to switch to STRP transmission.

In embodiments of the present disclosure, the event information includes change information of a number of activated panels and/or panels available for MTRP and/or STRP transmission.

In embodiments of the present disclosure, the change information of the number of activated panels and/or the panels available for STxMP transmission includes at least one of the following:
a suggested reduction in the number of activated panels and/or the number of panels available for MTRP and/or STRP transmission; or
a desired number of activated panels and/or a desired number of panels available for MTRP and/or STRP transmission.

In embodiments of the present disclosure, the event information includes terminal status information, in which the terminal status information indicates that the terminal currently cannot support STxMP.

In embodiments of the present disclosure, the terminal status information includes at least one of:
terminal power saving reminder information for reminding a network device that the terminal needs or has entered a power saving mode and cannot support STxMP; or
terminal overheating reminder information for reminding a network device that the terminal is in an overheated state and cannot support STxMP.

In embodiments of the present disclosure, the event information includes recovery reminder information, and the recovery reminder information reminds the network device that the terminal supports STxMP.

In embodiments of the present disclosure, the event information is carried in the radio resource control (RRC) signaling, or in the medium access control control element (MAC CE), or in the uplink control information (UCI).

According to the technical solutions of embodiments of the present disclosure, by receiving the event information reported by the terminal supporting STxMP, the network device can schedule the transmission parameter and perform the precoding indication for the terminal according to the event information reported by the terminal, enabling the uplink PUSCH transmission to support a higher transmission rate and a higher throughput rate, thus realizing optimization of the indication scheme for the terminal.

With regard to the device in above embodiment, the specific manner in which each module performs an operation is described in detail in the embodiments relating to the method, and will not be described in detail herein.

FIG. 8 is a block diagram of a communication system illustrated according to an illustrative embodiment. As illustrated in FIG. 8, the communication system 300 includes a terminal 310 and a network device 320.

The terminal is configured to perform any one of the communication methods provided by the embodiments of the present disclosure, and the network device is configured to perform any one of the communication methods provided by the embodiments of the present disclosure.

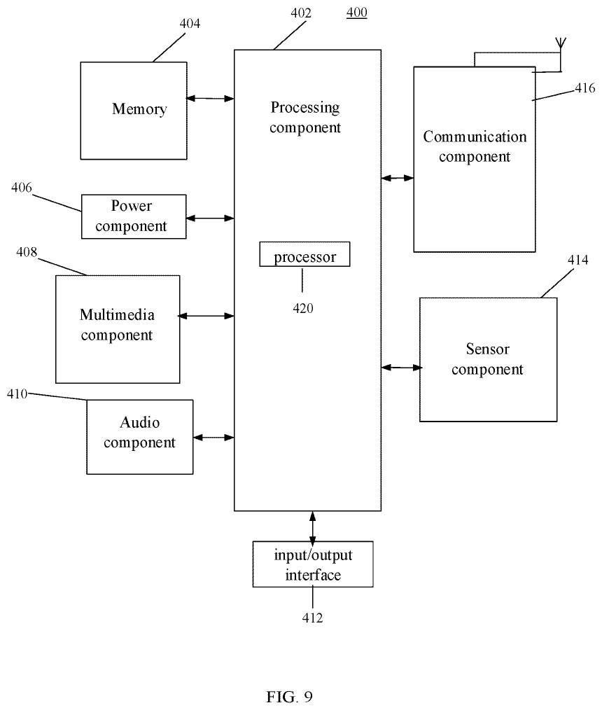

FIG. 9 is a block diagram of a communication device 400 illustrated according to an illustrative embodiment. For example, the device 400 may be a mobile phone, a computer, a digital broadcast terminal, a messaging device, a game console, a tablet device, a medical device, a fitness device, a personal digital assistant, etc.

As illustrated in FIG. 9, the device 400 may include one or a plurality of the following components: a processing component 402, a memory 404, a power component 406, a multimedia component 408, an audio component 410, an input/output (I/O) interface 412, a sensor component 414, and a communication component 416.

The processing component 402 generally controls overall operation of the device 400, such as operations related to display, call, data communication, camera and record. The processing component 402 may include one or a plurality of processors 420 to execute instructions, so as to achieve all or a part of steps of the above-described method. Additionally, the processing component 402 may include one or more modules, facilitating interaction between the processing component 402 and other components. For example, the processing component 402 may include a multimedia module, thereby facilitating interaction between the multimedia component 408 and the processing component 402.

The memory 404 is configured to store various types of data to support the operations of the device 400. Examples of these data include instructions, contact data, telephone book data, messages, pictures, videos, etc. for any application or method operated on the device 400. The memory 404 may be realized by any type of volatile, or non-volatile storage devices or combination thereof, such as a static random access memory (SRAM), an electrically erasable programmable read only memory (EEPROM), an erasable programmable read only memory (EPROM), a programmable read only memory (PROM), a read only memory (ROM), a magnetic memory, a flash memory, a magnetic or optical disk.

The power component 406 provides power for various components of the device 400. The power component 406 may include a power management system, one or more power sources, and other components associated with generating, managing and distributing power for the device 400.

The multimedia component 408 includes a screen that provides an output interface between the device 400 and the user. In some embodiments, the screen may include a liquid crystal display (LCD), and a touch panel (TP). If the screen includes the touch panel, the screen may be realized as a touch screen, so as to receive an input signal from the user. The touch panel includes one or a plurality of touch sensors to sense touch, swipe and gesture on the touch panel. The touch sensor not only can sense the boundary of the touch or swipe action, but also can detect duration time and pressure related to the touch or swipe operation. In in some embodiments, the multimedia component 408 includes a front camera and/or a rear camera. When the device 400 is in an operation mode, such as in a photographing or video mode, the front camera and/or the rear camera can receive external multimedia data. Each of the front camera and the rear camera may be a fixed optical lens system or has a focal length and optical zoom capability.

The audio component 410 is configured to output and/or input an audio signal. For example, the audio component 410 includes a microphone (MIC). The microphone is configured to receive external audio signal when the device 400 is in the operation mode, such as in a call mode, a record mode and a speech recognition mode. The received audio signal can be further stored in the memory 404 or transmitted via the communication component 416. In some embodiments, the audio component 410 further includes a speaker configured to output the audio signal.

The I/O interface 412 provides an interface between the processing component 402 and a peripheral interface module, which may be a keyboard, a click wheel, a button, or the like. The button may include but not limited to a homepage button, a volume button, a start button and a lock button.

The sensor component 414 includes one or a plurality of sensors configured to provide state assessments of various aspects of device 400. For example, the sensor component 414 may detect on/off state of the device 400, relative positioning of components. For example, the components may be a display and a keypad of the device 400. The sensor component 414 may further detect positional variation of the device 400 or one component of the device 400, presence or absence of contact between the user and the device 400, orientation or acceleration/deceleration of the device 400 and temperature variation of the device 400. The sensor component 414 may include a proximity sensor configured to detect presence of nearby objects without any physical contact. The sensor component 414 may also include an optical sensor, such as a COMS or CCD image sensor configured to use in an imaging application. In some embodiments, the sensor component 414 may further include an acceleration sensor, a gyro sensor, a magnetic sensor, a pressure sensor or a temperature sensor.

The communication component 416 is configured to facilitate wired or wireless communication between the device 400 and other devices. The device 400 may access to wireless network based on communication standard, such as Wi-Fi, 2G, or 3G, or combination thereof. In an illustrative embodiment, the communication component 416 receives a broadcast signal or information related to the broadcast from an external broadcast management system. In an illustrative embodiment, the communication component 416 further includes a near field communication (NFC) module to facilitate short-range communication. For example, the NFC module may be realized based on a radio frequency identification (RFID) technology, an infra-red data association (IrDA) technology, an ultra-wide band (UWB) technology, a Bluetooth (BT) technology and other technologies.

In an illustrative embodiment, the device 400 may be realized by one or a plurality of application specific integrated circuits (ASIC), digital signal processors (DSP), digital signal processing equipments (DSPD), programmable logic devices (PLD), field-programmable gate arrays (FPGA), controllers, microcontrollers, microprocessors or other electronic elements configured to execute the above-described method.

In illustrative embodiments, there is also provided a non-transitory computer-readable storage medium including instructions, such as a memory 404 including instructions, and the instructions is executable by the processor 420 of the device 400 to achieve the method described above. For example, the non-transitory computer readable storage medium may be ROM, random access memory (RAM), CD-ROM, magnetic tape, floppy disks, and optical data storage devices, among others.

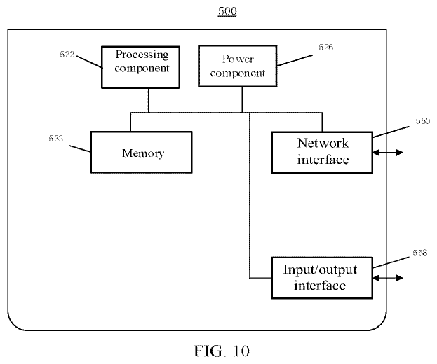

FIG. 10 is a block diagram of a communication device 500 illustrated according to an illustrative embodiment. For example, the device 500 may be provided as a server. As illustrated in FIG. 10, the device 500 includes a processing component 522 that further includes one or more processors, and a memory resource represented by a memory 532 for storing instructions, such as an application program, executable by the processing component 522. The application program stored in memory 532 may include one or more modules each corresponding to a set of instructions. Further, the processing component 522 is configured to execute instructions to perform the method described above.

The device 500 may also include a power component 526 configured to perform power management of the device 500, a wired or wireless network interface 550 configured to connect the device 500 to a network, and an input/output (I/O) interface 558. The device 500 may operate based on an operating system stored in the memory 532, such as Windows Server™, Mac OS X™, Unix™, Linux™, FreeBSD™, or the like.

It is further understood that “a plurality” in the present disclosure refers to two or more, and other quantifiers are similar. The term “and/or”, describes the association relationship of the associated objects, and means that there can be three types of relationships. For example, A and/or B, can mean that A exists alone, A and B exist at the same time, and B exists alone. The character “/” generally indicates that the associated objects before and after it are an “or” relationship. The singular form “a”, “the” and “this” is also intended to include the plural form, unless other meanings are explicitly expressed in the context.

It is further understood that the meaning of words such as “in response to” and “if” as referred to in the present disclosure depends on the context and the actual scenario of use, and the word “in response to” as used here may be interpreted as “when” or “upon” or “if”.

It should be further understood that, although the terms “first”, “second” may be employed to describe various information, these information should not limited by these terms. These terms are only used to distinguish the information of the same type from each other, and do not indicate special order or importance. In fact, the expressions “first”, “second”, etc. are completely interchangeable. For example, a first information may be referred to as a second information without departing from the scope of the present disclosure, and similarly, the second information may also be referred to as the first information.

It could be further understood that, although the operations in embodiments of the present disclosure are described in a specific order in the drawings, it should not be construed as requiring that the operations be performed in the specific order illustrated or the serial order, or requiring that all operations illustrated be performed to obtain the desired result. In certain circumstances, multitasking and parallel processing may be advantageous.

Other embodiments of the present disclosure will readily occur to a person skilled in the art upon consideration of the specification and practice of the invention disclosed herein. The present application is intended to cover any variations, uses, or adaptations of the present disclosure that follow the general principles of the present disclosure and include common knowledge or conventional technical means in the art not disclosed by the present disclosure.

It should be understood that the present disclosure is not limited to the precise structures described above and illustrated in the accompanying drawings, and that various modifications and changes may be made without departing from the scope thereof. The scope of the present disclosure is limited only by the scope of the appended claims.

1. A communication method, performed by a terminal, comprising:
transmitting event information, wherein the terminal supports uplink simultaneous transmission via a multi-panel (STxMP), the event information is used to schedule a transmission parameter for the terminal, and the transmission parameter comprises at least one of a transmission scheme or precoding information.

2. The method according to claim 1, wherein the event information comprises at least one of:
suggesting to switch a currently scheduled transmission from simultaneous transmission via at least one of a multi-panel or a multi-transmission reception point (MTRP) to a single-panel or a single-transmission reception point (STRP) transmission;
suggesting to switch a currently scheduled transmission from simultaneous transmission via at least one of a multi-panel or a MTRP to a MTRP time division multiplexing (TDM) transmission;
suggesting to switch a currently scheduled transmission from simultaneous transmission via at least one of a multi-panel or a MTRP to a STRP transmission;
suggesting to switch to at least one of a single-panel or a STRP transmission;
suggesting to switch to a MTRP TDM transmission; or
suggesting to switch to a STRP transmission.

3. The method according to claim 1, wherein the event information comprises change information of a number of at least one of activated panels or panels available for at least one of a MTRP or a STRP transmission.

4. The method according to claim 3, wherein the change information of the number of at least one of activated panels or panels available for at least one of the MTRP or the STRP transmission comprises at least one of:
a suggested reduction in at least one of the number of activated panels or number of panels available for at least one of the MTRP or the STRP transmission; or
at least one of a desired number of activated panels or a desired number of panels available for at least one of the MTRP or the STRP transmission.

5. The method according to claim 1, wherein the event information comprises terminal status information, wherein the terminal status information indicates that the terminal currently cannot support STxMP.

6. The method according to claim 5, wherein the terminal status information is reported in response to the terminal satisfying at least one of:
a remaining power of the terminal is less than a first power threshold;
the terminal is configured in a power saving mode; or
the terminal detects that a device area temperature is greater than a first temperature threshold.

7. The method according to claim 5, wherein the terminal status information comprises at least one of:
terminal power saving reminder information for reminding a network device that the terminal needs or has entered a power saving mode and cannot support STxMP; or
terminal overheating reminder information for reminding a network device that the terminal is in an overheated state and cannot support STxMP.

8. The method according to claim 1, wherein the event information comprises recovery reminder information, wherein the recovery reminder information reminds a network device that the terminal supports STxMP.

9. The method according to claim 1, wherein the event information is carried in radio resource control (RRC) signaling, or in a medium access control control element (MAC CE), or in uplink control information (UCI).

10. A communication method, performed by a network device, comprising:
receiving event information reported by a terminal, wherein the terminal supports uplink simultaneous transmission via a multi-panel (STxMP); and
scheduling a transmission parameter based on the event information, wherein the transmission parameter comprises at least one of a transmission scheme or precoding information.

11. The method according to claim 10, wherein the event information comprises at least one of:
suggesting to switch a currently scheduled transmission from simultaneous transmission via at least one of a multi-panel or a multi-transmission reception point (MTRP) to at least one of a single-panel or a single-transmission reception point (STRP) transmission,
suggesting to switch a currently scheduled transmission from simultaneous transmission via at least one of a multi-panel or a MTRP to a MTRP time division multiplexing (TDM) transmission;
suggesting to switch a currently scheduled transmission from simultaneous transmission via at least one of a multi-panel or a MTRP to a STRP transmission;
suggesting to switch to at least one of a single-panel or a STRP transmission;
suggesting to switch to MTRP TDM transmission; or
suggesting to switch to STRP transmission.

12. The method according to claim 10, wherein the event information comprises change information of a number of at least one of activated panels or panels available for at least one of a MTRP or a STRP transmission.

13. The method according to claim 12, wherein the change information of the number of at least one of activated panels or panels available for at least one of the MTRP or the STRP transmission comprises at least one of:
a suggested reduction in at least one of the number of activated panels and/or the number of panels available for at least one of the MTRP or the STRP transmission; or
at least one of a desired number of activated panels or desired number of panels available for at least one of the MTRP or the STRP transmission.

14. The method according to claim 10, wherein the event information comprises terminal status information, wherein the terminal status information indicates that the terminal currently cannot support STxMP.

15. The method according to claim 14, wherein the terminal status information comprises at least one of:
terminal power saving reminder information for reminding a network device that the terminal needs or has entered a power saving mode and cannot support STxMP; or
terminal overheating reminder information for reminding a network device that the terminal is in an overheated state and cannot support STxMP.

16. The method according to claim 10, wherein the event information comprises recovery reminder information, wherein the recovery reminder information reminds a network device that the terminal supports STxMP.

17. The method according to claim 10, wherein the event information is carried in radio resource control (RRC) signaling, or in medium access control control element (MAC CE), or in uplink control information (UCI).

18-19. (canceled)

20. A communication system, comprising:
a terminal configured to transmit event information; and
a network device configured to receive the event information reported by the terminal, and schedule a transmission parameter based on the event information,
wherein the terminal supports uplink simultaneous transmission via multi-panel (STxMP), the event information is used to schedule the transmission parameter for the terminal, and the transmission parameter comprises at least one of a transmission scheme or precoding information.

21. A communication device, comprising:
a processor; and
a memory configured to store instructions executable by the processor,
wherein the processor is configured to:
perform the method according to claim 1.

22. A communication device, comprising:
a processor; and
a memory configured to store instructions executable by the processor,
wherein the processor is configured to:
perform the method according to claim 10.

23-24. (canceled)
